(19) United States
(12) Patent Application Publication
(10) Pub. No.: US 2020/0143567 A1
(43) Pub. Date: May 7, 2020

(54) Protective Cover Device

(71) Applicant: Tangible Play, Inc., Palo Alto, CA (US)

(72) Inventors: Jon Karl Dukerschein, Pacifica, CA (US); Mark Solomon, Palo Alto, CA (US)

(21) Appl. No.: 16/677,469

(22) Filed: Nov. 7, 2019

Related U.S. Application Data
(60) Provisional application No. 62/757,100, filed on Nov. 7, 2018.

(51) Int. Cl. G06T 7/80; G06F 1/16; H04B 1/3888; H04N 5/232

(52) U.S. Cl. CPC G06T 7/80; G06F 1/1632; G06F 1/1686; G06F 2200/1633; H04N 5/232; G06F 1/1626; H04B 1/3888

(57) ABSTRACT

A protective cover device is described. In an example implementation, the protective cover device includes a top surface; a back surface connected to the top surface, the top surface and the back surface extending around one or more device surfaces of a computing device; and an adapter window including a portion of the top surface and a portion of the back surface, the adapter window being movable relative to the protective cover device to expose a device edge of the computing device to receive a camera adapter.

### BACKGROUND

The present disclosure relates to a protective cover device.

Electronic devices are often installed in a protective case. The protective case often is positioned around the electronic device to protect the electronic device from being damaged. Therefore, the protective case usually increases the size of the electronic device, and causes the electronic device to be incompatible to its peripherals. An example peripheral of the electronic device is a stand on which the electronic device may be placed to provide hand-free experience to a user when the user uses the electronic device. The stand may also situate the electronic device in a specific position so that the electronic device can capture certain data for applications implemented on the electronic device to operate. However, the electronic device being installed in the protective case may no longer fit into the stand because of the size change caused by the protective case. Therefore, the user may need to obtain a different stand specifically designed to use the electronic device with the protective case. This existing solution is usually undesirable to the user due to additional device cost. Alternatively, the user may remove the electronic device from the protective case before placing the electronic device on the stand. This existing solution is usually inconvenient for the user and generally increases the risk of the electronic device being damaged due to the lack of device protection.

### SUMMARY

According to one innovative aspect of the subject matter in this disclosure, a protective cover device is described. The protective cover device includes a top surface; a back surface connected to the top surface, the top surface and the back surface extending around one or more device surfaces of a computing device; and an adapter window including a portion of the top surface and a portion of the back surface, the adapter window being movable relative to the protective cover device to expose a device edge of the computing device to receive a camera adapter.

Implementations may include one or more of the following features. The protective cover device where the device edge of the computing device is exposed when the adapter window is at an open position; and the camera adapter is compatibly placeable on an exposed portion of the device edge of the computing device. The protective cover device where the adapter window is connected to a surface of the protective cover device at a connecting element, the adapter window being rotatable around the connecting element relative to the surface of the protective cover device to an open position; and the surface of the protective cover device is the top surface or the back surface of the protective cover device. The protective cover device where the adapter window is rotatable around the connecting element by a rotation angle satisfying a rotation angle threshold. The protective cover device where the adapter window rests against the surface of the protective cover device when the adapter window is at the open position. The protective cover device where the surface of the protective cover device includes a first area adapted to receive the adapter window when the adapter window is at the open position; and the adapter window is detachably coupleable to the first area. The protective cover device where the first area is an indent portion compatible with the adapter window on the surface of the protective cover device, the adapter window being flush with the surface of the protective cover device when the adapter window is in the first area. The protective cover device where the adapter window rests against the camera adapter that is situated on the device edge of the computing device when the adapter window is at an open position. The protective cover device that includes a case marker indicating that the computing device is installed in the protective cover device. The protective cover device where the case marker is positioned at a bottom area on a front surface of the protective cover device and located within a field of view of a camera of the computing device. The protective cover device where the protective cover device containing the computing device is placeable on a stand, the stand including a stand marker positioned on a front portion of the stand; and the case marker of the protective cover device blocks the stand marker of the stand from being visually detectable to a camera of the computing device when the protective cover device containing the computing device is situated on the stand. The protective cover device where the stand marker is positioned on an indent area of the front portion of the stand; and the case marker includes a protrusion extending outward from a front surface of the protective cover device, the protrusion of the case marker occupying a space above the indent area of the stand and blocking the stand marker on the indent area of the stand from the camera of the computing device. The protective cover device where the protective cover device containing the computing device is placeable in a stand channel of a stand; and the protective cover device includes an exterior portion along an edge of the protective cover device, a width dimension of the protective cover device at the exterior portion being compatible with a width dimension of the stand channel of the stand. The protective cover device that includes a ledge element extending outward from a front surface of the protective cover device and along an edge of the protective cover device. The protective cover device where the protective cover device containing the computing device is placeable in a stand channel of a stand; and the protective cover device includes an exterior portion located between the ledge element and the edge of the protective cover device, a width dimension of the protective cover device at the exterior portion being compatible with a width dimension of the stand channel of the stand. The protective cover device where a height dimension of the exterior portion of the protective cover device is compatible with a depth dimension of the stand channel of the stand.

Generally another innovative aspect of the subject matter described in this disclosure may be embodied in a protective cover device that includes a top surface; a back surface connected to the top surface, the top surface and the back surface extending around one or more device surfaces of a computing device; and an adapter window including a portion of the top surface and a portion of the back surface, the adapter window being movable relative to the protective cover device to expose a device edge of the computing device to receive a camera adapter, the camera adapter being placeable on an exposed portion of the device edge and over a camera of the computing device to direct a field of view of the camera of the computing device.

Implementations may include one or more of the following features. The protective cover device that includes a case marker indicating that the computing device is installed in the protective cover device. The protective cover device where the case marker is positioned at a bottom area on a front surface of the protective cover device and located within the field of view of the camera of the computing device; and the computing device is adapted to capture, using the camera of the computing device, a video stream, detect in the video stream, using a detector executable on the computing device, the case marker positioned on the protective cover device, and determine that the computing device is installed in the protective cover device.

Generally another innovative aspect of the subject matter described in this disclosure may be embodied in a protective cover device that includes a top surface; a back surface connected to the top surface, the top surface and the back surface extending around one or more device surfaces of a computing device; an adapter window including a portion of the top surface and a portion of the back surface, the adapter window being movable relative to the protective cover device to expose a device edge of the computing device to receive a camera adapter, the camera adapter being placeable on an exposed portion of the device edge and over a camera of the computing device; a case marker positioned at a bottom area on a front surface of the protective cover device and located within a field of view of the camera of the computing device, the case marker indicating that the computing device is installed in the protective cover device; a ledge element extending outward from the front surface of the protective cover device and along an edge of the protective cover device; and an exterior portion located between the ledge element and the edge of the protective cover device, wherein a width dimension of the protective cover device at the exterior portion is compatible with a width dimension of a stand channel of a stand in which the protective cover device containing the computing device is placeable, and a height dimension of the exterior portion of the protective cover device is compatible with a depth dimension of the stand channel of the stand.

Other implementations of one or more of these aspects and other aspects described in this document include corresponding systems, apparatus, and computer programs, configured to perform the actions of the methods, encoded on computer storage devices. The above and other implementations are advantageous in a number of respects as articulated through this document. Moreover, it should be understood that the language used in the present disclosure has been principally selected for readability and instructional purposes, and not to limit the scope of the subject matter disclosed herein.

### BRIEF DESCRIPTION OF THE DRAWINGS

The disclosure is illustrated by way of example, and not by way of limitation in the figures of the accompanying drawings in which like reference numerals are used to refer to similar elements.

FIGS. 1A and 1B respectively illustrate perspective views from a front perspective and a rear perspective of an example protective cover device containing a computing device and situated on a stand.

FIG. 2 is a block diagram illustrating an example computer system that is used with a computing device installed in a protective cover device.

FIG. 3 is a block diagram illustrating an example computing device.

FIGS. 4A and 4B respectively illustrate perspective views from a rear perspective of an example protective cover device with an adapter window at a closed position and at an open position.

FIG. 5 is a portion of a perspective view from a front perspective of an example protective cover device containing a computing device and situated on a stand.

FIG. 6 is a cross-sectional view of an example protective cover device containing a computing device and situated on a stand.

FIGS. 7A-7C illustrate cross-sectional views of an example protective cover device containing a computing device relative to a stand channel of a stand.

FIG. 8 is a perspective view of an example protective cover device containing a computing device and situated on a stand in a horizontal position.

FIG. 9 is a flowchart of an example method for processing a video stream.

### DETAILED DESCRIPTION

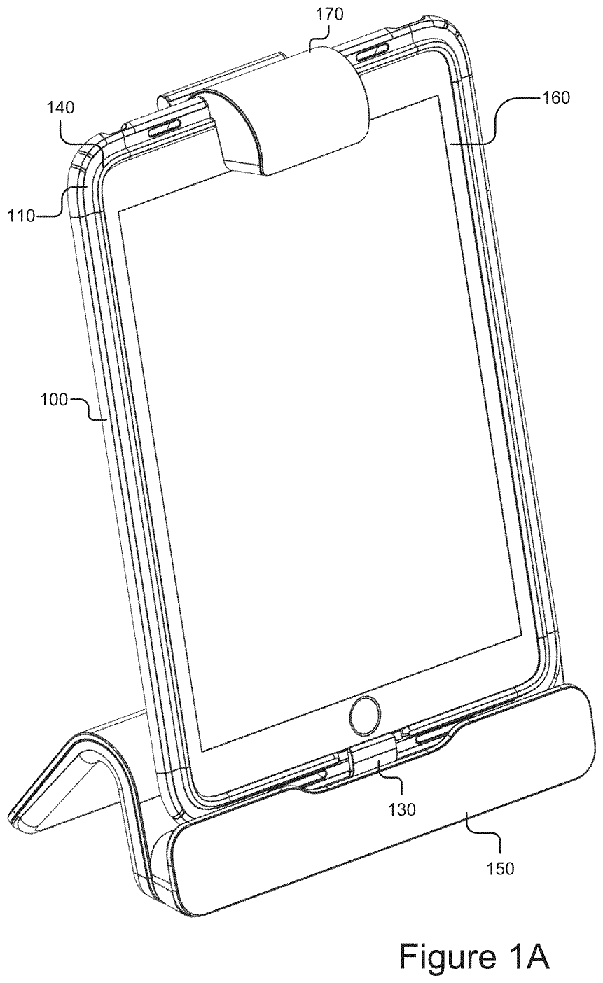

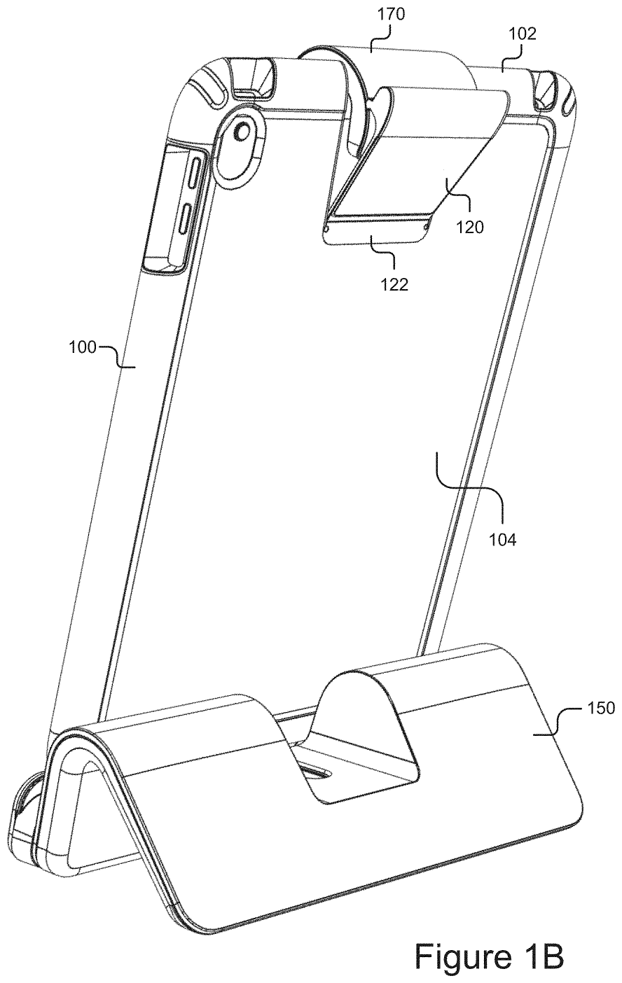

FIGS. 1A and 1B illustrate an example protective cover device 100 that can protect a computing device and allow the computing device installed in the protective cover device 100 to be used with a camera adapter and a stand.

As depicted in FIG. 1A, the protective cover device 100 may contain a computing device 160 in the protective cover device 100 and may be situated on a stand 150. As depicted in FIG. 1B, the protective cover device 100 may include an adapter window 120 that is formed out of a portion of a top surface 102 and a portion of a back surface 104 of the protective cover device 100. In some embodiments, the adapter window 120 may be movable relative to the protective cover device 100. Therefore, the adapter window 120 may be moved to an open position to expose a device edge of the computing device 160 in the protective cover device 100 to receive a camera adapter 170 on the device edge. The camera adapter 170 may be compatibly placed on the exposed portion of the device edge and over a camera 172 (not shown) of the computing device 160 to redirect the field of view of the camera 172 (not shown). Thus, the camera adapter 170 can be used for the computing device 160 even when the computing device 160 is installed in the protective cover device 100 for device protection.

As depicted in FIG. 1A, the protective cover device 100 may include a case marker 130 indicating that the computing device 160 is installed in the protective cover device 100. In some embodiments, the case marker 130 may be positioned on a front surface of the protective cover device 100 and located within the field of view of the camera 172 (not shown) of the computing device 160 when the computing device 160 is contained in the protective cover device 100 and a field-of-view of the camera 172 is redirected by the camera adapter 170. As a result, the case marker 130 may be visually detectable to the camera 172. In particular, the case marker 130 may be exposed and visible to the camera 172. Therefore, the case marker 130 may be captured by the camera 172, and thus may be depicted and detectable in the captured image. In some embodiments, when the case marker 130 is detected in the captured image, the computing device 160 may determine that the computing device 160 is installed in the protective cover device 100. Thus, the computing device 160 may compute the camera position of the camera 172 based on the device attributes of the computing device 160 and the case profile of the protective cover device 100, and uses the calibration profile associated with the camera position of the camera 172 to perform image calibration on the video stream captured by the camera 172. The implementation of the case marker 130 is advantageous, because it enables the computing device 160 to determine a configuration in which the computing device 160 is set up without requiring the user to input this data, and thus the user experience can be improved.

As depicted in FIG. 1A, the protective cover device 100 may include a ledge element 140 extending along one or more edges of the protective cover device 100. As depicted, the ledge element 140 may extend outward from the front surface of the protective cover device 100 to protect the display screen of the computing device 160. As an example, the computing device 160 covered in the protective cover device 100 may be dropped on a hard surface with the display screen of the computing device 160 facing the hard surface. Because the ledge element 140 raises above the front surface of the protective cover device 100, the ledge element 140 of the protective cover device 100 may be in contact with the hard surface instead of the display screen of the computing device 160, thereby preventing the display screen of the computing device 160 from being damaged.

In some embodiments, the computing device 160 may be placed on the stand 150 to facilitate a user in using the electronic device without holding it in his or her hands. The stand 150 may also situate the computing device 160 in a specific position so that the camera 172 of the computing device 160 can capture data from a consistent perspective to accurately operate the applications implemented on the computing device 160. In some implementations, covering the computing device 160 in the protective cover device 100 may increase the size of the computing device 160, and thus causing the computing device 160 to be incompatible with the stand 150, without adapting the stand 150. For example, the computing device 160 may no longer fit into a stand channel 156 (not shown) of the stand 150 due its size expansion caused by the protective cover device 100.

In some embodiments, an exterior portion of the protective cover device 100 may be adapted to fit the protective cover device 100 that contains the computing device 160 into the stand channel 156 (not shown) of the stand 150. The exterior portion may extend along one or more edges of the protective cover device 100. In some embodiments, the exterior portion may be located between the ledge element 140 and the edge of the protective cover device 100 along which the ledge element 140 may extend. In some embodiments, the width dimension of the protective cover device 100 at the exterior portion may be compatible with the width dimension of the stand channel 156 of the stand 150. In some embodiments, the height dimension of the exterior portion may be compatible with the depth dimension of the stand channel 156 of the stand 150. As a result, the computing device 160 installed in the protective cover device 100 may fit into the stand channel 156 of the stand 150 at the exterior portion of the protective cover device 100 regardless of the outward protrusion of the ledge element 140 and/or the size expansion at other portions of the protective cover device 100. This implementation is advantageous, because it eliminates the need for the user to obtain a separate stand to use the computing device 160 with the protective cover device 100. Therefore, the risk of the computing device 160 being damaged can be lowered without incurring additional device cost or buying additional hardware to adapt the stand 150.

In some embodiments, the user may set up a display positioning system on a physical activity surface to position the computing device 160. The display positioning system may include the stand 150 and the camera adapter 170. In some embodiments, the stand 150 may be situated on the physical activity surface and may be configured to receive the computing device 160 and position the computing device 160 in an upright or angled position. The camera adapter 170 may be configured to situate over the camera 172 (not shown) of the computing device 160 to redirect the field of view of the camera 172. By redirecting the field of view of the camera 172, the camera 172 can capture video stream and/or images of objects and user interactions on an activity scene of the physical activity surface. The activity scene may be a portion of the physical activity surface that is located within the field of view of the camera 172. In some embodiments, the computing device 160 being placed on the stand 150 and receiving the camera adapter 170 may be installed in the protective cover device 100 to protect the computing device 160.

As discussed above, the computing device 160 may be placed on the stand 150 situated on the physical activity surface. In some embodiments, the physical activity surface may be a physical surface on which the user may create a tangible work (e.g., drawings, painting, models, etc.), manipulate and/or interact with various tangible objects (e.g., puzzle pieces, programming tiles, etc.), etc. The physical activity surface may be vertical, horizontal, or positioned at any angle suitable for the user to interact with the tangible objects. The physical activity surface may have any color, texture, pattern, and topography. For example, the physical activity surface may be substantially flat or disjointed/discontinuous in nature. Non-limiting examples of the physical activity surface include a table, a desk, a counter, a wall, a whiteboard, a chalkboard, a ground surface, a customized surface, etc. In some embodiments, the physical activity surface may include a medium on which the user may render works (e.g., paper, canvas, fabric, clay, foam, etc.).

In some embodiments, the physical activity surface may be preconfigured for certain activities. For example, the physical activity surface may include the activity scene (e.g., a drawing area). In some embodiments, the activity scene may be integrated with the stand 150. Alternatively, the activity scene may be distinct from the stand 150 but located adjacent to the stand 150. In some embodiments, the activity scene may indicate the portion of the physical activity surface that is within the field of view of the camera 172. In some embodiments, the size of the activity scene on the physical activity surface may be bounded by the field of view of the camera 172 and may be adapted by the camera adapter 170 and/or by configuring the stand 150 to adjust the position of the camera 172. In some embodiments, the activity scene may be a light projection (e.g., pattern, context, shapes, etc.) projected onto the physical activity surface.

In some embodiments, the stand 150 may be situated on the physical activity surface or located proximate to the physical activity surface, and the computing device 160 may be placed on the stand 150. The computing device 160 may include activity applications capable of providing the user with a virtual scene that is responsive to the tangible objects and/or the user interactions with the tangible objects on the physical activity surface in real-time. In some embodiments, the computing device 160 may be placed on the stand 150 situated in front of the user so that the user can conveniently see the display screen of the computing device 160 while interacting with the tangible objects on the physical activity surface. Non-limiting examples of the computing device 160 include mobile phones (e.g., feature phones, smart phones, etc.), tablets, laptops, desktops, netbooks, TVs, set-top boxes, media streaming devices, portable media players, navigation devices, personal digital assistants, etc.

As depicted in FIGS. 1A and 1B, the computing device 160 may be installed in the protective cover device 100. The protective cover device 100 may include one or more surfaces that respectively cover one or more device surfaces of the computing device 160 and protect the computing device 160, such as from scratches, drops, liquids, etc. Especially in situations where the computing device 160 is marketed to be used by children, the protective cover device 100 can protect the computing device 160 from damage. In some embodiments, the surfaces of the protective cover device 100 may be continuous. Alternatively, the surfaces of the protective cover device 100 may include opening slots through which peripheral devices (e.g., charging cables, earbuds, speaker, etc.) may be connected to the computing device 160 when the computing device 160 is installed in the protective cover device 100.

In some embodiments, the surfaces of the protective cover device 100 may form a compartment that contains the computing device 160 with a front opening to receive the computing device 160 in the compartment. In some embodiments, the front opening of the protective cover device 100 may be covered by a transparent panel made of glass, clear plastic, etc. In some embodiments, the transparent panel may be movable relative to the front opening to place the computing device 160 in the compartment through the front opening. Once the computing device 160 is placed in the compartment, the display screen of the computing device 160 may occupy the front opening and may be accessible to the user at the front opening. The transparent panel may then be positioned on the display screen to protect the display screen from damages. In some embodiments, to protect the computing device 160 installed in the protective cover device 100, the protective cover device 100 may also include impact-resistant material integrated into various portions of the protective cover device 100 (e.g., corners, back surface, etc.). Non-limiting examples of the impact-resistant material include rubber, metal, plastic, etc. Other features of the protective cover device 100 are also possible and contemplated. The protective cover device 100 is described in details below with reference to FIGS. 1A-9.

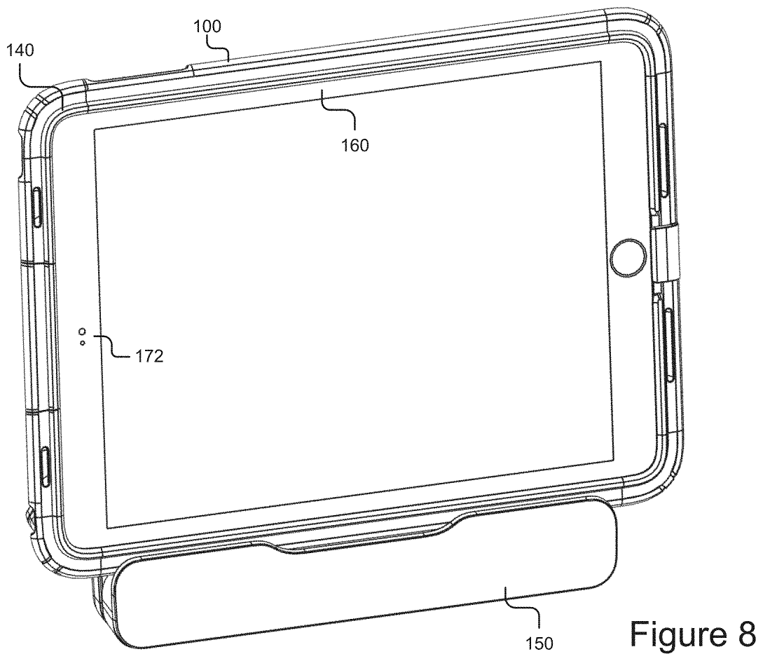

As discussed elsewhere herein, the computing device 160 may include the camera 172 (also referred to as a video capture device) for capturing a video stream of the physical activity surface. Alternatively, the camera 172 may be an independent unit distinct from the computing device 160 and coupled to the computing device 160 via a wired or wireless connection to provide the computing device 160 with the video stream being captured. In some embodiments, the camera 172 may be a front-facing camera or a rear-facing camera of the computing device 160. For example, as depicted in FIGS. 1A and 8, the camera 172 may be a front-facing camera being equipped with the camera adapter 170 that adapts the field of view of the camera 172 to include at least a portion of the physical activity surface. The activity scene of the physical activity surface that is captured by the camera 172 may also be referred to herein as the activity surface.

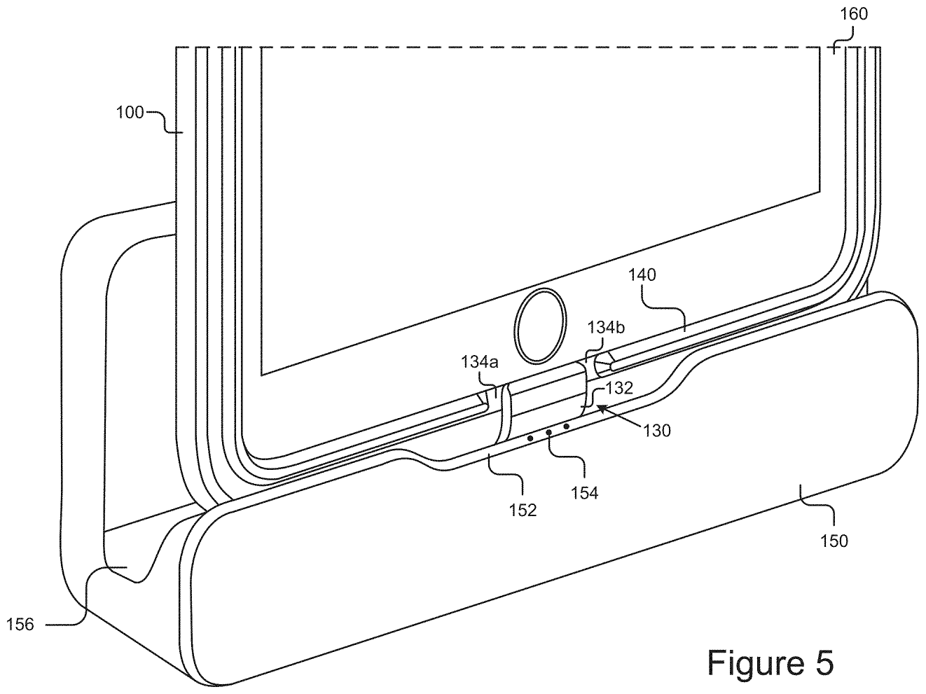

As depicted in FIG. 1A, the computing device 160 and/or the camera 172 may be positioned and/or supported by the stand 150. The stand 150 may be configured to position the camera 172 at an optimal position to accurately capture the objects in the activity scene of the physical activity surface. The position of the camera 172 relative to the physical activity surface may be referred to herein as the camera position or the capture position of the camera 172. In some embodiments, as the computing device 160 is placed on the stand 150, the display screen of the computing device 160 may be in a position that facilitates the user in viewing and interacting with the content on the display screen while the user is simultaneously interacting with the physical environment (e.g., the activity scene of the physical activity surface). For example, the stand 150 may position the computing device 160 at a leaning angle relative to a horizontal line (e.g., 60°). In some embodiments, the stand 150 may be configured to situate on the physical activity surface, receive and sturdily hold the computing device 160 so that the computing device 160 remains still during use. In some embodiments, the stand 150 may include a stand marker 154 positioned on a front portion of the stand 150 (see FIG. 5). The stand marker 154 may indicate the configuration of the stand 150 (e.g., leg position of the stand 150), the device attributes of the computing device 160 that is placeable on the stand 150 (e.g., type of device, brand name, device model, etc.), etc. The stand marker 154 may also indicate other types of information.

In some embodiments, the camera adapter 170 (also referred to as an adapter) may adapt the camera 172 of the computing device 160 to capture substantially and only the activity scene of the physical activity surface, although other implementations are also possible and contemplated. As an example, the camera 172 may be the front-facing camera and the camera adapter 170 may split the field of view of the front-facing camera into multiple scenes. In this example, the camera 172 may capture the activity scene that includes multiple portions of the physical activity surface, and determine tangible works in any portion of the activity scene. In another example, the camera adapter 170 may redirect a rear-facing camera of the computing device 160 toward the front-side of the computing device 160 to capture the activity scene of the physical activity surface that is located in front of the computing device 160. In some embodiments, the camera adapter 170 may define one or more sides of the scene being captured (e.g., top, left, right, with bottom open).

In some embodiments, the camera adapter 170 may include a slot adapted to receive a device edge of the computing device 160 and retain (e.g., secure, grip, etc.) the camera adapter 170 on the device edge of the computing device 160. In some embodiments, the camera adapter 170 may be positioned over the camera 172 to direct the field of view of the camera 172 toward the physical activity surface. As discussed elsewhere herein, the computing device 160 may be placed on the stand 150 situated on the physical activity surface. In some embodiments, the camera adapter 170 may adjust the field of view of the camera 172 to include the activity scene on the physical activity surface that is located proximate to the stand 150 and also include a front portion of the stand 150. In some embodiments, the field of view of the camera 172 may be adjusted to also include at least a portion of the front surface of the protective cover device 100 in which the computing device 160 is installed.

In some embodiments, the camera adapter 170 may be retained in an adapter slot on the stand 150 when the camera adapter 170 is not in use. In some embodiments, the adapter slot may be formed perpendicular to and intersecting with the stand channel 156 of the stand 150 in which the computing device 160 may be received. Alternatively, the adapter slot may be formed on the stand 150 such that the camera adapter 170 may not block the stand channel 156 of the stand 150 when the camera adapter 170 is placed in the adapter slot. Thus, the stand 150 may receive and support the computing device 160 in the stand channel 156 and at the same time keep the camera adapter 170 secured instead of being loose and potentially separated from other components of the display positioning system (e.g., lost, etc.). The stand channel 156 being unblocked may also facilitate the user in viewing and interacting with the computing device 160 situated in the stand channel 156 of the stand 150. In some embodiments, the camera adapter 170 may have a tapered shape that is compatible with the adapter slot, and thus the camera adapter 170 may be easily placeable in the adapter slot. In some embodiments, the adapter slot may include magnetic material to magnetically couple to the corresponding magnetic material integrated in the camera adapter 170, thereby detachably securing the camera adapter 170 in place to prevent the camera adapter 170 from being easily jarred out of the adapter slot. Alternatively, the adapter slot may retain the camera adapter 170 by the tension applied between the sides of camera adapter 170 and the surfaces of the adapter slot.

In some embodiments, the camera adapter 170 may include one or more optical elements, such as mirrors and/or lenses, to adapt the standard field of view of the camera 172. To adapt the field of view of the camera 172, the mirrors and/or lenses of the camera adapter 170 may be positioned at an angle to redirect and/or modify the light being reflected from physical activity surface into the camera 172. For example, the camera adapter 170 may include a mirror being angled to redirect the light reflected from the physical activity surface in front of the computing device 160 into a front-facing camera of the computing device 160. In another example, the computing device 160 may include a front-facing camera having a fixed line of sight relative to the display screen of the computing device 160. The camera adapter 170 may be detachably connected to the computing device 160 over the camera 172 to augment the line of sight of the camera 172 so that the camera 172 can capture the physical activity surface (e.g., surface of a table).

As an example, the camera adapter 170 may include a mirror being positioned at the mirror angle of 54° (±5°) from the edge of the slot in which the camera adapter 170 may receive the device edge of the computing device 160 to situate on the device edge. In some embodiments, the mirror angle may be specific to the camera 172, and thus the computing devices 160 having different cameras 172 and/or different camera configurations of the camera 172 may need to be used with different camera adapters 170 having different mirror angles. In some embodiments, the mirror of the camera adapter 170 may be adjustable to be positioned at various mirror angles, and thus the camera adapter 170 can be used with various computing devices 160. A range of mirror angles are also possible and contemplated.

In some embodiments, the mirrors and/or lenses of the camera adapter 170 may be laser quality glass or may be polished. In some embodiments, the mirrors and/or lenses may include a first surface that is a reflective element. The first surface may be a coating/thin film capable of redirecting light without having to pass through the glass of a mirror and/or lens. Alternatively, a first surface of the mirrors and/or lenses may be a coating/thin film and a second surface may be a reflective element. In these embodiments, the light may pass through the coating twice. However, since the coating is extremely thin relative to the glass, the distortive effect may be reduced as compared to a conventional mirror. This implementation is advantageous, because it can reduce the distortive effect of a conventional mirror in a cost effective way.

In some embodiments, the camera adapter 170 may include a series of optical elements (e.g., mirrors) that wrap the light reflected off of the physical activity surface located in front of the computing device 160 into a rear-facing camera of the computing device 160 so that it can be captured. In some embodiments, the camera adapter 170 may adapt a portion of the field of view of the camera 172 (e.g., the front-facing camera) and leave a remaining portion of the field of view unaltered so that the camera 172 may capture multiple scenes. In some embodiments, the camera adapter 170 may also include optical element(s) that are configured to provide different effects, such as enabling the camera 172 to capture a larger portion of the physical activity surface. For example, the camera adapter 170 may include a convex mirror that provides a fisheye effect to capture a larger portion of the physical activity surface than would otherwise be capturable by a standard configuration of the camera 172.

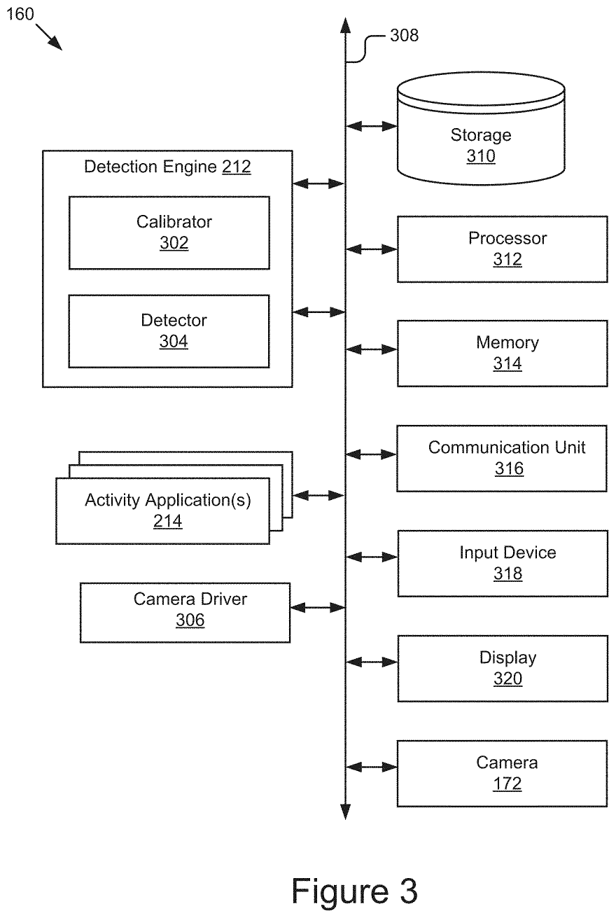

In some embodiments, the camera 172 may be configured to include at least a portion of the stand 150 and/or a portion of the protective cover device 100 within its field of view. For example, the field of view of the camera 172 may include an area on the front portion of the stand 150 that has the stand marker 154, and include an area on the front surface of the protective cover device 100 that has the case marker 130. In some embodiments, the stand 150 may be considered a reference point to perform geometric and/or image calibration of the camera 172. In some embodiments, the calibrator 302 (e.g., see FIG. 3) may calibrate the camera 172 (e.g., adjust the white balance, focus, exposure, etc.) based on the configuration in which the computing device 160 is set up. For example, the camera 172 may be calibrated based on the case profile of the protective cover device 100 in which the computing device 160 is contained, the stand profile of the stand 150 on which the protective cover device 100 containing the computing device 160 is situated, etc.

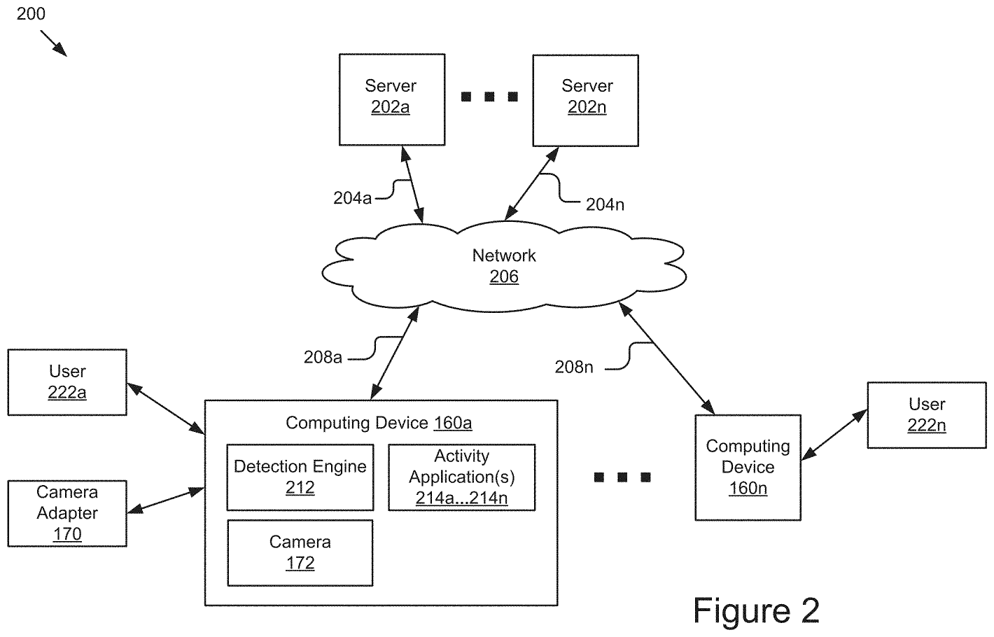

FIG. 2 is a block diagram illustrating an example computer system 200 that is used with the computing device 160 installed in the protective cover device 100. As depicted, the system 200 may include computing devices 160a . . . 160n and servers 202a . . . 202n communicatively coupled via a network 206. In FIG. 2 and the remaining figures, a letter after a reference number, e.g., “160a”, represents a reference to the element having that particular reference number. A reference number in the text without a following letter, e.g., “160”, represents a general reference to instances of the element bearing that reference number. It should be understood that the system 200 depicted in FIG. 2 is provided by way of example and that the system 200 and/or further systems contemplated by this present disclosure may include additional and/or fewer components, may combine components and/or divide one or more of the components into additional components, etc. For example, the system 100 may include any number of servers 202, computing devices 160, and/or networks 206. As depicted in FIG. 2, the computing device 160 may be coupled to the network 206 via the signal line 208 and the server 202 may be coupled to the network 206 via the signal line 204. The computing device 160 may be accessed by user 222.

The network 206 may include any number of networks and/or network types. For example, the network 206 may include, but is not limited to, one or more local area networks (LANs), wide area networks (WANs) (e.g., the Internet), virtual private networks (VPNs), mobile (cellular) networks, wireless wide area network (WWANs), WiMAX® networks, Bluetooth® communication networks, peer-to-peer networks, other interconnected data paths across which multiple devices may communicate, various combinations thereof, etc.

The computing device 160 may be a computing device that has data processing and communication capabilities. In some embodiments, the computing device 160 may include a processor (e.g., virtual, physical, etc.), a memory, a power source, a network interface, and/or other software and/or hardware components, such as front and/or rear facing cameras, display screen, graphics processor, wireless transceivers, keyboard, firmware, operating systems, drivers, various physical connection interfaces (e.g., USB, HDMI, etc.). In some embodiments, the computing devices 160 may be coupled to and communicate with one another and with other entities of the system 200 via the network 206 using a wireless and/or wired connection. As discussed elsewhere herein, the system 200 may include any number of computing devices 160 and the computing devices 160 may be the same or different types of devices (e.g., tablets, mobile phones, desktop computers, laptop computers, etc.).

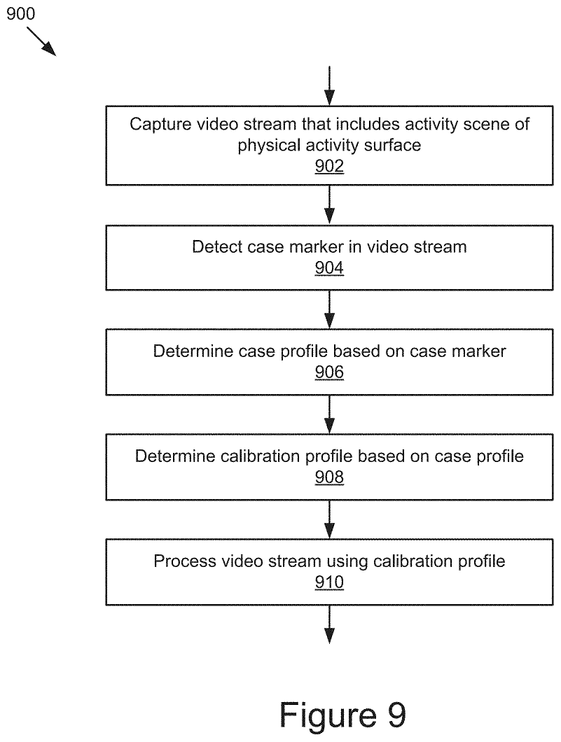

As depicted in FIG. 2, the computing device 160 may include the camera 172, a detection engine 212, and one or more activity applications 214. The computing device 160 and/or the camera 172 may be equipped with the camera adapter 170 as discussed elsewhere herein. In some embodiments, the detection engine 212 may detect and/or recognize tangible objects located in the activity scene of the physical activity surface, and cooperate with the activity application(s) 214 to provide the user 222 with a virtual experience that incorporates in substantially real-time the tangible objects and the user manipulation of the tangible objects in the physical environment. As an example, the detection engine 212 may process the video stream captured by the camera 172 to detect and recognize a tangible work created by the user on the activity scene. The activity application 214 may generate a visualization of the tangible work created by the user, and display to the user a virtual scene in which an animated character may interact with the visualization of the tangible work. In another example, the detection engine 212 may process the video stream captured by the camera 172 to detect and recognize a sequence of programming tiles organized by the user on the activity scene. The activity application 214 may determine a series of commands represented by the sequence of programming tiles and execute these commands in order, thereby causing a virtual object to perform corresponding actions in a virtual environment being displayed to the user. The components and operations of the detection engine 212 and the activity application 214 are described in details below with reference to at least FIGS. 3 and 9.

The server 202 may include one or more computing devices that have data processing, storing, and communication capabilities. In some embodiments, the server 202 may include one or more hardware servers, server arrays, storage devices and/or storage systems, etc. In some embodiments, the server 202 may be a centralized, distributed and/or a cloud-based server. In some embodiments, the server 202 may include one or more virtual servers that operate in a host server environment and access the physical hardware of the host server (e.g., processor, memory, storage, network interfaces, etc.) via an abstraction layer (e.g., a virtual machine manager).

The server 202 may include software applications operable by one or more processors of the server 202 to provide various computing functionalities, services, and/or resources, and to send and receive data to and from the computing devices 160. For example, the software applications may provide the functionalities of internet searching, social networking, web-based email, blogging, micro-blogging, photo management, video/music/multimedia hosting/sharing/distribution, business services, news and media distribution, user account management, or any combination thereof. It should be understood that the server 202 may also provide other network-accessible services.

In some embodiments, the server 202 may include a search engine capable of retrieving results that match one or more search criteria from a data store. As an example, the search criteria may include an image and the search engine may compare the image to product images in its data store (not shown) to identify a product that matches the image. In another example, the detection engine 212 and/or the storage 310 (e.g., see FIG. 3) may request the search engine to provide information that matches a physical drawing, an image, and/or a tangible object extracted from a video stream.

It should be understood that the system 200 illustrated in FIG. 2 is provided by way of example, and that a variety of different system environments and configurations are contemplated and are within the scope of the present disclosure. For example, various functionalities may be moved from a server to a client, or vice versa and some implementations may include additional or fewer computing devices, services, and/or networks, and may implement various client or server-side functionalities. In addition, various entities of the system 200 may be integrated into a single computing device or system or divided into additional computing devices or systems, etc.

FIG. 3 is a block diagram of an example computing device 160. As depicted, the computing device 160 may include a processor 312, a memory 314, a communication unit 316, an input device 318, a display 320, a storage 310, and the camera 172 communicatively coupled by a bus 308. It should be understood that the computing device 160 is not limited to such and other components are also possible and contemplated.

The processor 312 may execute software instructions by performing various input/output, logical, and/or mathematical operations. The processor 312 may have various computing architectures to process data signals including, for example, a complex instruction set computer (CISC) architecture, a reduced instruction set computer (RISC) architecture, and/or an architecture implementing a combination of instruction sets. The processor 312 may be physical and/or virtual, and may include a single core or plurality of processing units and/or cores.

The memory 314 may be a non-transitory computer-readable medium that is configured to store and provide access to data to other components of the computing device 160. In some embodiments, the memory 314 may store instructions and/or data that are executable by the processor 312. For example, the memory 314 may store the detection engine 212, the activity applications 214, and a camera driver 306. The memory 314 may also store other instructions and data, including, for example, an operating system, hardware drivers, other software applications, data, etc. The memory 314 may be coupled to the bus 308 for communication with the processor 312 and other components of the computing device 160.

The communication unit 316 may include one or more interface devices (I/F) for wired and/or wireless connectivity with the network 206 and/or other devices. In some embodiments, the communication unit 316 may include transceivers for sending and receiving wireless signals. For example, the communication unit 316 may include radio transceivers for communication with the network 206 and for communication with nearby devices using close-proximity connectivity (e.g., Bluetooth®, NFC, etc.). In some embodiments, the communication unit 316 may include ports for wired connectivity with other devices. For example, the communication unit 316 may include a CAT-5 interface, Thunderbolt™ interface, FireWire™ interface, USB interface, etc.

The display 320 (also referred to as display screen) may display electronic images and data output by the computing device 160 for presentation to the user 222. The display 320 may include any display device, monitor or screen, including, for example, an organic light-emitting diode (OLED) display, a liquid crystal display (LCD), etc. In some embodiments, the display 320 may be a touch-screen display capable of receiving input from one or more fingers of the user 222. For example, the display 320 may be a capacitive touch-screen display capable of detecting and interpreting multiple points of contact with the display surface. In some embodiments, the computing device 160 may include a graphic adapter (not shown) for rendering and outputting the images and data for presentation on display 320. The graphic adapter may be a separate processing device including a separate processor and memory (not shown) or may be integrated with the processor 312 and memory 314.

The input device 318 may include any device for inputting information into the computing device 160. In some embodiments, the input device 318 may include one or more peripheral devices. For example, the input device 318 may include a keyboard (e.g., a QWERTY keyboard), a pointing device (e.g., a mouse or touchpad), a microphone, a camera, etc. In some implementations, the input device 318 may include a touch-screen display capable of receiving input from one or more fingers of the user 222. In some embodiments, the functionality of the input device 318 and the display 320 may be integrated, and the user 222 may interact with the computing device 160 by touching a surface of the display 320. For example, the user 222 may interact with an emulated keyboard (e.g., soft keyboard or virtual keyboard) displayed on the touch-screen display 320 by contacting the display 320 in the keyboard regions using his or her fingers.

The detection engine 212 may include a calibrator 302 and a detector 304. The components 212, 302, and 304 may be communicatively coupled to one another and/or to other components 214, 306, 310, 312, 314, 316, 318, 320, and/or 172 of the computing device 160 by the bus 308 and/or the processor 312. In some embodiments, the components 212, 302, and 304 may be sets of instructions executable by the processor 312 to provide their functionality. In some embodiments, the components 212, 302, and 304 may be stored in the memory 314 of the computing device 160 and may be accessible and executable by the processor 312 to provide their functionality. In any of the foregoing implementations, these components 212, 302, and 304 may be adapted for cooperation and communication with the processor 312 and other components of the computing device 160.

The calibrator 302 includes software and/or logic for performing image calibration on the video stream captured by the camera 172. In some embodiments, to perform the image calibration, the calibrator 302 may calibrate the images in the video stream to adapt to the capture position of the camera 172. The capture position of the camera 172 may depend on the computing device 160 attributes, stand attributes and/or the configuration of the stand 150 on which the computing device 160 is situated, and/or may depend on the case profile of the protective cover device 100 in which the computing device 160 is installed (if any). In some embodiments, the protective cover device 100 and the stand 150 may elevate the camera 172 of the computing device 160 relative to the physical activity surface on which the stand 150 is placed. The stand 150 may also position the camera 172 at a tilt angle relative to the horizontal line. Capturing the video stream from this camera position may cause distortion effects on the video stream. Therefore, the calibrator 302 may adjust one or more operation parameters of the camera 172 to compensate for these distortion effects. Examples of the operation parameters being adjusted include, but are not limited to, focus, exposure, white balance, aperture, f-stop, image compression, ISO, depth of field, noise reduction, focal length, etc. Performing image calibration on the captured video stream is advantageous, because it can optimize the images of the video stream to accurately detect the objects depicted therein, and thus the operations of the activity applications 214 based on the objects detected in the video stream can be significantly improved.

In some embodiments, the calibrator 302 may also calibrate the images to compensate for the characteristics of the activity surface (e.g., size, angle, topography, etc.). For example, the calibrator 302 may perform the image calibration to account for the discontinuities and/or the non-uniformities of the activity surface, thereby enabling accurate detection of objects on the activity surface when the stand 150 and/or the computing device 160 is set up on various activity surfaces (e.g., bumpy surface, beds, tables, whiteboards, etc.). In some embodiments, the calibrator 302 may calibrate the images to compensate for optical effect caused by the camera adapter 170 and/or the optical elements of the camera 172. In some embodiments, the calibrator 302 may also calibrate the camera 172 to split its field of view into multiple portions with the user being included in one portion of the field of view and the activity surface being included in another portion of the field of view of the camera 172.

In some embodiments, different types of computing device 160 may use different types of camera 172 that have different camera information. For example, the tablets made by Apple may use a different type of camera 172 from the tablets made by Amazon. In some embodiments, the calibrator 302 may use the camera information specific to the camera 172 of the computing device 160 to calibrate the video stream captured by the camera 172 (e.g., focal length, distance between the camera 172 to the bottom edge of the computing device 160, etc.). As discussed elsewhere herein, the calibrator 302 may also use the camera position at which the camera 172 is located to perform the image calibration. In some embodiments, the calibrator 302 may determine the camera position of the camera 172 based on the stand marker 154 positioned on the stand 150 and/or the case marker 130 positioned on the protective cover device 100.

The detector 304 includes software and/or logic for processing the video stream captured by the camera 172 to detect the tangible objects present in the activity surface, the stand marker 154 positioned on the stand 150, and/or the case marker 130 positioned on the protective cover device 100 in the video stream. In some embodiments, to detect an object in the video stream, the detector 304 may analyze the images of the video stream to determine line segments, and determine the object that has the contour matching the line segments using the object data in the storage 310. In some embodiments, the detector 304 may provide the tangible objects detected in the video stream to the activity applications 214 and provide the stand marker 154 and/or the case marker 130 detected in the video stream to the calibrator 302. In some embodiments, the detector 304 may store the tangible objects, the stand marker 154, and/or the case marker 130 detected in the video stream in the storage 310 for retrieval by these components. In some embodiments, the detector 304 may determine whether the line segments and/or the object associated with the line segments can be identified in the video stream, and instruct the calibrator 302 to calibrate the images of the video stream accordingly.

The activity application 214 includes software and/or logic executable on the computing device 160. In some embodiments, the activity application 214 may receive the tangible objects detected in the video stream of the activity surface from the detector 304. In some embodiments, the activity application 214 may generate a virtual environment that incorporates, in real-time, the virtualization of the tangible objects and the user manipulation of the tangible objects on the activity surface, and display the virtual environment to the user on the computing device 160. Non-limiting examples of the activity application 214 include video games, learning applications, assistive applications, storyboard applications, collaborative applications, productivity applications, etc. Other types of activity application are also possible and contemplated.

The camera driver 306 includes software storable in the memory 314 and operable by the processor 312 to control/operate the camera 172. For example, the camera driver 306 may be a software driver executable by the processor 312 for instructing the camera 172 to capture and provide a video stream and/or a still image, etc. In some embodiments, the camera driver 306 may be capable of controlling various features of the camera 172 (e.g., flash, aperture, exposure, focal length, etc.). In some embodiments, the camera driver 306 may be communicatively coupled to the camera 172 and other components of the computing device 160 via the bus 308, and these components may interface with the camera driver 306 to capture video and/or still images using the camera 172.

As discussed elsewhere herein, the camera 172 is a video capture device (e.g., a camera) adapted to capture video streams and/or images of the physical activity surface. In some embodiments, the camera 172 may be coupled to the bus 308 for communication and interaction with the other components of the computing device 160. In some embodiments, the camera 172 may include a lens for gathering and focusing light, a photo sensor including pixel regions for capturing the focused light, and a processor for generating image data based on signals provided by the pixel regions. The photo sensor may be any type of photo sensor (e.g., a charge-coupled device (CCD), a complementary metal-oxide-semiconductor (CMOS) sensor, a hybrid CCD/CMOS device, etc.). In some embodiments, the camera 172 may include a microphone for capturing sound. Alternatively, the camera 172 may be coupled to a microphone that is coupled to the bus 308 or included in another component of the computing device 160. In some embodiments, the camera 172 may also include a flash, a zoom lens, and/or other features. In some embodiments, the processor of the camera 172 may store video and/or still image data being captured in the memory 314 and/or provide the video and/or still image data to other components of the computing device 160, such as the detection engine 212 and/or the activity applications 214.

The storage 310 is a non-transitory storage medium that stores and provides access to various types of data. Non-limiting examples of the data stored in the storage 310 include video stream and/or still images captured by the camera 172, object data describing various tangible objects (e.g., object contour, color, shape and size, etc.), object detection result indicating the tangible objects, the stand marker 154, and/or the case marker 130 detected in the video stream and/or still images, etc. In some embodiments, the data stored in the storage 310 may also include one or more stand profiles, each stand profile may be associated with a stand 150 and may include one or more stand attributes describing the stand 150. For example, the stand profile may include the length dimension, the width dimension, the height dimension of the stand 150, the width dimension and the depth dimension of the stand channel 156 of the stand 150, the leaning angle at which the computing device 160 may be situated in the stand channel 156 of the stand 150, etc. In some embodiments, the stand profile may also include stand marker data describing the stand marker 154 of the stand 150 (e.g., color, shape and size, appearance feature, relative location, etc.). Other types of data in the stand profile are also possible and contemplated.

In some embodiments, the storage 310 may store one or more case profiles, each case profile may be associated with a protective cover device 100 and may include one or more case attributes describing the protective cover device 100. For example, the case profile may include the height dimension (e.g., 24 cm), the length dimension (e.g., 17 cm), the width dimensions at various portions of the protective cover device 100 (e.g., 0.75 cm at the exterior portion, 1.5 cm at the ledge element 140, 1 cm at the remaining portions), the height dimension of the exterior portion of the protective cover device 100 (e.g., 2 cm from the corresponding edge of the protective cover device 100), etc. In some embodiments, the case profile may also include adapter window data describing the adapter window 120 of the protective cover device 100 (e.g., window size, rotation angle threshold, etc.), case marker data describing the case marker 130 of the protective cover device 100 (e.g., color, shape and size, appearance feature, relative location, etc.), etc. Other types of data in the case profile are also possible and contemplated.

In some embodiments, the storage 310 may store one or more calibration profiles, each calibration profile may be associated with a camera position of the camera 172 relative to the physical activity surface and include calibration parameters for calibrating the video stream and/or still images captured by the camera 172 at the camera position. In some embodiments, the computing device 160 may be covered in the protective cover device 100 and the computing device 160 contained in the protective cover device 100 may be situated on the stand 150. Thus, the calibration profile may be associated with the case profile of the protective cover device 100 and the stand profile of the stand 150 on which the camera position of the camera 172 is dependent. Non-limiting examples of the calibration parameters in the calibration profile include a distance attribute indicating the distance between the camera 172 and the physical activity surface, the tilt attribute indicating the tilt angle of the camera 172 relative to the horizontal line, etc. Other calibration parameters are also possible and contemplated.

In some embodiments, the storage 310 may be included in the memory 314 or another storage device coupled to the bus 308. In some embodiments, the storage 310 may be included in a distributed data store, such as a cloud-based computing and/or data storage system. In some embodiments, the storage 310 may include a database management system (DBMS). The DBMS may be a structured query language (SQL) DBMS. For example, the storage 310 may store data in an object-based data store or multi-dimensional tables including rows and columns, and may manipulate (i.e., insert, query, update, and/or delete) data entries stored in the storage 310 using programmatic operations (e.g., SQL queries and statements or a similar database manipulation library). Other implementations of the storage 310 with additional characteristics, structures, acts, and functionalities are also possible and contemplated.

As discussed elsewhere herein, the protective cover device 100 may contain the computing device 160 to protect the computing device 160 and also enable the computing device 160 installed in the protective cover device 100 to be used with the camera adapter 170 and the stand 150. Thus, the camera adapter 170 and the stand 150 that are compatible with the computing device 160 can also be used for the computing device 160 covered in the protective cover device 100 without to purchase or provide additional hardware. As depicted in FIGS. 1A and 1B, the protective cover device 100 may include one or more surfaces that are connected to wrap around one or more device surfaces of the computing device 160 to protect the computing device 160. For example, the protective cover device 100 may include a front surface, a back surface, a top surface, a bottom surface, and one or more side surfaces that respectively cover at least a portion of a front surface, a back surface, a top surface, a bottom surface, and one or more side surfaces of the computing device 160. In this present disclosure, the front surface of the computing device 160 may refer to the device surface that includes the display 320 and the camera 172, and the top surface of the computing device 160 may refer to the device surface that is proximate to the camera 172. The top edge of the computing device 160 may refer to the device edge of the computing device 160 that is proximate to the camera 172, and the bottom edge of the computing device 160 may refer to the device edge that is opposite to the camera 172 of the computing device 160.

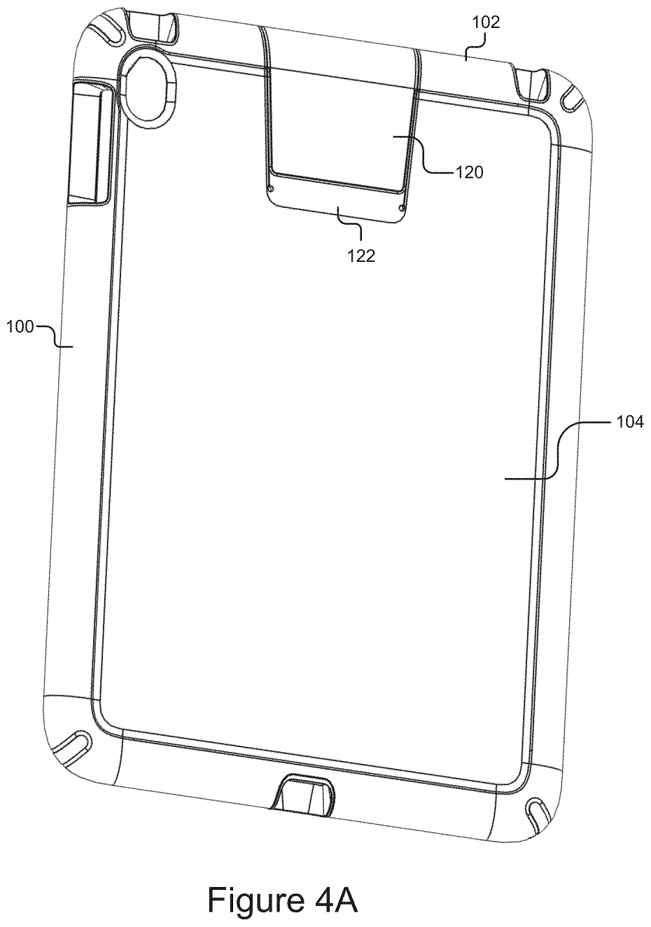

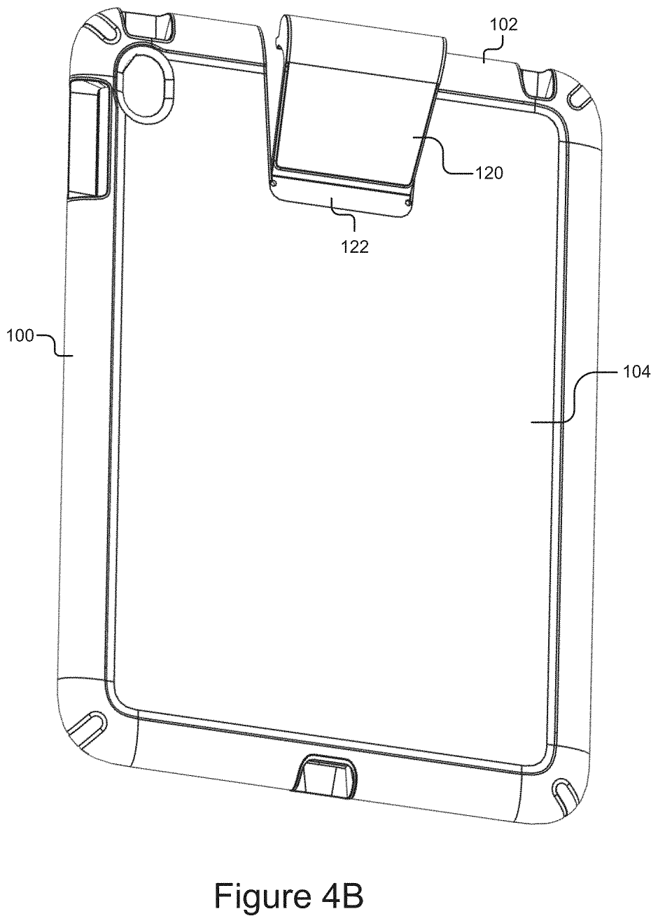

As depicted in FIG. 1B, the protective cover device 100 may include the top surface 102 connected to the back surface 104. As discussed above, the top surface 102 and the back surface 104 of the protective cover device 100 may extend around the top surface and the back surface of the computing device 160. Perspective views of the protective cover device 100 from a rear perspective are illustrated in FIGS. 4A and 4B. As depicted, the protective cover device 100 may include the adapter window 120. The adapter window 120 may include a portion of the top surface 102 and a portion of the back surface 104. In some embodiments, the adapter window 120 may be connected to a surface of the protective cover device 100 at a connecting element 122. For example, the connecting element 122 may connect the adapter window 120 to the top surface 102 and/or to the back surface 104 of the protective cover device 100 at one or more connecting points or along a connecting edge. Non-limiting examples of the connecting element 122 include hinges, latches, screws, snapping fasteners, etc. In some embodiments, the adapter window 120 may be rotatable around the connecting element 122 relative to the surface of the protective cover device 100 to which the adapter window 120 is connected. Thus, the adapter window 120 may be movable relative to the protective cover device 100.

In some embodiments, the adapter window 120 may be movable relative to the protective cover device 100 to be at a closed position or at an open position. As depicted in FIG. 4A, when the adapter window 120 is at the closed position, the adapter window 120 may cover a portion of a device edge of the computing device 160 as a part of the protective cover device 100 in which the computing device 160 is installed. In some embodiments, the device edge of the computing device 160 being covered by the adapter window 120 may be the top edge proximate to the camera 172 of the computing device 160. As depicted in FIGS. 1B and 4B, when the adapter window 120 is at the open position, the portion of the device edge of the computing device 160 may no longer be covered by the adapter window 120. Thus, the adapter window 120 may expose the device edge of the computing device 160 to receive the camera adapter 170 on the device edge. In some embodiments, when the adapter window 120 is at the open position, at least a portion of the device edge of the computing device 160 is uncovered by the adapter window 120. Depending on the size of the adapter window 120, the adapter window 120 may expose a portion of the device edge or an entire device edge of the computing device 160 when the adapter window 120 is at the open position.

In some embodiments, the camera adapter 170 may be compatibly placeable on the exposed portion of the device edge of the computing device 160. The exposed portion of the device edge may have a length compatible with the size of the camera adapter 170. Therefore, the camera adapter 170 may fit into the exposed portion of the device edge of the computing device 160, and the camera adapter 170 can be accommodated within the area formed out of the exposed portion of the device edge. In some embodiments, the portion of the device edge that is exposable by the adapter window 120 may be proximate to the camera 172 of the computing device 160 so that the camera adapter 170 may be placed over the camera 172 when the camera adapter 170 is situated on this portion of the device edge, and thus the camera adapter 170 may be correctly positioned to redirect the field of view of the camera 172.

As discussed elsewhere herein, the adapter window 120 may be rotatable around the connecting element 122 relative to the surface of the protective cover device 100. As discussed above, the surface of the protective cover device 100 may be the top surface 102 or the back surface 104 of the protective cover device 100 to which the adapter window 120 is connected. In some embodiments, the adapter window 120 may be rotatable around the connecting element 122 by a rotation angle that satisfies a rotation angle threshold (e.g., less than) 45°. In some embodiments, the rotation angle threshold of the adapter window 120 may be proportional to the size of the camera adapter 170.

In some embodiments, once the adapter window 120 is rotated relative to the surface of the protective cover device 100 to the open position, the adapter window 120 may rest against the surface of the protective cover device 100 when the adapter window 120 is at the open position. In some embodiments, the surface of the protective cover device 100 may include a first area adapted to receive the adapter window 120 when the adapter window 120 is at the open position. The first area may be an indent portion compatible with the adapter window 120 on the surface of the protective cover device 100. For example, the first area may be formed on the back surface 104 of the protective cover device 100 and have the shape and size of the adapter window 120. Thus, the adapter window 120 may fit into the first area on the back surface 104 when the adapter window 120 rests against the back surface 104 of the protective cover device 100 at the open position. In some embodiments, the adapter window 120 may be flush with the surface of the protective cover device 100 when the adapter window 120 is in the first area.

In some embodiments, the adapter window 120 may be detachably coupleable to the first area to securely retain the adapter window 120 in the first area on the surface of the protective cover device 100. For example, the adapter window 120 may include a magnetic component to magnetically couple to a corresponding magnetic component integrated in the first area on the surface of the protective cover device 100. In another example, the adapter window 120 may include a retaining element (e.g., protrusion, latch, detent, etc.), and the first area on the surface of the protective cover device 100 may include a receiving element compatible to the retaining element. The receiving element of the first area may receive the retaining element of the adapter window 120, thereby coupling the adapter window 120 to the first area on the surface of the protective cover device 100. Alternatively, the adapter window 120 may be coupled to the surface of the protective cover device 100 using other coupling components (e.g., snapping fasteners, Velcro pads, etc.). Retaining the adapter window 120 against the surface of the protective cover device 100 is advantageous, because it prevents the adapter window 120 from being loose and easily damaged when the adapter window 120 is at the open position.

In some embodiments, instead of resting against the surface of the protective cover device 100, the adapter window 120 may rest against the camera adapter 170 at the open position as depicted in FIG. 1B. In some embodiments, the adapter window 120 may include a spring element (or elastic element) coupled to the connecting element 122. The adapter window 120 being moved to the open position may cause the spring element to be stretched. Thus, when the adapter window 120 is at the open position and the camera adapter 170 is placed on the portion of the device edge exposed by the adapter window 120, the elastic force of the spring element to return the spring element from its stretched position to its rest position may cause the adapter window 120 to rest against the camera adapter 170 situated on the device edge of the computing device 160. In some embodiments, the adapter window 120 may be removable from the surface of the protective cover device 100 to which the adapter window 120 is connected. Thus, the adapter window 120 may be removed from the protective cover device 100 to expose the portion of the device edge of the computing device 160, and the camera adapter 170 may be placed on the exposed portion of the device edge. Other implementations of the adapter window 120 are also possible and contemplated.

In some embodiments, the protective cover device 100 may include the case marker 130 indicating that the computing device 160 is installed in the protective cover device 100. In some embodiments, the case marker 130 may also indicate one or more device attributes of the computing device 160 placeable in the protective cover device 100. For example, the case marker 130 may indicate the device category (e.g., tablet, mobile phone, etc.), the brand name (e.g., Apple), the device model (e.g., iPad Air), etc., of the computing device 160. As illustrated in FIGS. 1A and 5, in some implementations, the case marker 130 may be positioned at the bottom area on the front surface of the protective cover device 100. The bottom area of the protective cover device 100 may be proximate to the bottom edge of the computing device 160 when the computing device 160 is installed in the protective cover device 100. It should be understood that the case marker 130 may be positioned at other areas and/or on other surfaces of the protective cover device 100.

In some embodiments, the case marker 130 may be located within the field of view of the camera 172 of the computing device 160 when the computing device 160 is installed in the protective cover device 100 and situated on the stand 150. For example, the field of view of the camera 172 may be redirected by the camera adapter 170 or adjusted by configuring the stand 150 (e.g., repositioning legs of the stand 150) to include the activity scene located in front of the stand 150 on the physical activity surface and also include at least a portion of the protective cover device 100 that has the case marker 130. As a result, the case marker 130 can be captured by the camera 172 of the computing device 160. In some embodiments, the case marker 130 of the protective cover device 100 may be visually detectable to the camera 172 of the computing device 160. In particular, the case marker 130 may be exposed and visible to the camera 172. Therefore, the case marker 130 may be captured by the camera 172, and thus may be depicted and detectable in the captured image.

In some embodiments, the case marker 130 may include one or more marker elements. Non-limiting examples of the marker elements include dots, characters, symbols, images, objects, slots, etc., that can be incorporated into the protective cover device 100. In some embodiments, the case marker 130 may have impact on the visual detectability of other markers in the display positioning system, such as by blocking the other markers in the display positioning system, etc. As an example, the stand 150 may include the stand marker 154 positioned on the front portion of the stand 150. When the computing device 160 is not covered in the protective cover device 100 and the computing device 160 is situated on the stand 150, the stand marker 154 of the stand 150 may be visually detectable to the camera 172 of the computing device 160. In particular, the stand marker 154 may be exposed and visible to the camera 172. Therefore, the stand marker 154 may be captured by the camera 172, and thus may be depicted and detectable in the captured image. On the other hand, when the computing device 160 is installed in the protective cover device 100 and the protective cover device 100 containing the computing device 160 is situated on the stand 150, the stand marker 154 of the stand 150 may be hidden from the camera 172 of the computing device 160 by the case marker 130 of the protective cover device 100, and thus the case marker 130 of the protective cover device 100 may block the stand marker 154 of the stand 150 from being visually detectable to the camera 172 of the computing device 160. As a result, the stand marker 154 may no longer be exposed and visible to the camera 172. Therefore, the stand marker 154 may not be captured by the camera 172, and thus may not be depicted and detected in the captured image.

An example of the case marker 130 of the protective cover device 100 and the stand marker 154 of the stand 150 is illustrated in FIG. 5. As depicted, the stand 150 may include the stand marker 154 positioned on an indent area 152 of the front portion of the stand 150. In this example, the stand marker 154 may include 3 dot marks. As discussed above, when the computing device 160 is not covered in the protective cover device 100 and the computing device 160 is placed on the stand 150, the stand 150 may situate the computing device 160 in a position at which the stand marker 154 on the indent area 152 of the stand 150 is exposed and visible to the camera 172 of the computing device 160. Thus, the stand marker 154 may be visually detectable to the camera 172.

As depicted in FIG. 5, the case marker 130 of the protective cover device 100 may include a protrusion 132 extending outward from the front surface of the protective cover device 100. In this example, the stand marker 154 may also include a slot 134a and a slot 134b located on two sides of the protrusion 132. In some embodiments, when the computing device 160 is installed in the protective cover device 100 and the protective cover device 100 containing the computing device 160 is placed on the stand 150, the protrusion 132 of the case marker 130 on the protective cover device 100 may occupy the space above the indent area 152 of the stand 150 on which the stand marker 154 is located. Thus, the protrusion 132 of the case marker 130 of the protective cover device 100 may lie between the stand marker 154 of the stand 150 and the camera 172 of the computing device 160, thereby blocking the stand marker 154 on the indent area 152 of the stand 150 from the camera 172 of the computing device 160. As a result, the case marker 130 of the protective cover device 100 may be exposed and visually detectable to the camera 172 while the stand marker 154 of the stand 150 may not.

As discussed elsewhere herein, the configuration in which the computing device 160 is set up may impact the camera position at which the camera 172 of the computing device 160 may capture the video stream of the activity scene on the physical activity surface. As an example of the configuration in which the computing device 160 is set up, the computing device 160 may be installed in the protective cover device 100, and the protective cover device 100 containing the computing device 160 may be placed in the stand channel 156 of the stand 150 situated on the physical activity surface. Thus, the distance between the camera 172 of the computing device 160 and the physical activity surface may be increased by the distance between the stand channel 156 of the stand 150 and the physical activity surface on which the stand 150 is situated, and by the distance between the bottom edge of the computing device 160 and the bottom edge of the protective cover device 100 that covers the computing device 160. Accordingly, the stand 150 and the protective cover device 100 may elevate the camera 172 of the computing device 160 to a higher camera position relative to the physical activity surface, and the camera 172 may capture the video stream from this camera position. Therefore, to assist in accurately detecting objects depicted in the video stream for the operations of the activity applications 214, the calibration of the images in the video stream may be adapted based on the configuration in which the computing device 160 is set up.

An example method 900 for processing the video stream is depicted in FIG. 9. In block 902, the camera 172 of the computing device 160 may capture the video stream that includes the activity scene of the physical activity surface. As discussed elsewhere herein, the stand 150 may be configured and placed on the physical activity surface. For example, the stand 150 may include adjustable legs, and the adjustable legs of the stand 150 may be retracted or extended to modify the distance between the stand channel 156 of the stand 150 and the physical activity surface. The adjustable legs of the stand 150 may also be adjusted to different leg positions relative to one another to modify the leaning angle of the computing device 160 being placed in the stand channel 156 of the stand 150. In some embodiments, the computing device 160 may be installed in the protective cover device 100. As the computing device 160 is installed in the protective cover device 100, the adapter window 120 of the protective cover device 100 may be moved to the open position to expose the portion of the device edge of the computing device 160 as discussed elsewhere herein, and the camera adapter 170 may be placed on the exposed portion of the device edge to situate over the camera 172 of the computing device 160. The protective cover device 100 containing the computing device 160 may then be placed in the stand channel 156 of the stand 150 that is situated on the physical activity surface. Alternatively, the computing device 160 may be placed in the stand channel 156 of the stand 150 without being covered in the protective cover device 100.

In block 904, the detector 304 may detect the case marker 130 in the video stream. As discussed elsewhere herein, the case marker 130 may be positioned at the bottom area on the front surface of the protective cover device 100 and may indicate that the computing device 160 is currently contained in the protective cover device 100. In some embodiments, the detector 304 may apply an object detection algorithm to the image of the video stream to detect the case marker 130 on the front surface of the protective cover device 100 depicted in the image, and match the case marker 130 to the case marker data of various protective cover devices in the storage 310. In some embodiments, if the case marker 130 is detected in the video stream, the detector 304 may determine that the computing device 160 is installed in the protective cover device 100.

In some embodiments, in addition to the case marker 130 of the protective cover device 100, the detector 304 may also detect the stand marker 154 of the stand 150 in the video stream. As discussed elsewhere herein, the stand marker 154 may be positioned on the front portion of the stand 150 and may indicate the configuration and/or the stand attributes of the stand 150. In some embodiments, the detector 304 may apply an object detection algorithm to the image of the video stream to detect the stand marker 154 on the front portion of the stand 150 depicted in the image, and match the stand marker 154 to the stand marker data of various stands in the storage 310. In some embodiments, when the computing device 160 is installed in the protective cover device 100 and the protective cover device 100 containing the computing device 160 is placed on the stand 150, the case marker 130 of the protective cover device 100 may block the stand marker 154 of the stand 150 from the camera 172 of the computing device 160 as discussed elsewhere herein. In this implementation, if the case marker 130 of the protective cover device 100 is depicted and detected in the video stream, the stand marker 154 of the stand 150 may not be depicted in the video stream and may not be detected in the video stream by the detector 304.

In block 906, the calibrator 302 may determine the case profile associated with the protective cover device 100 based on the case marker 130. In some embodiments, the calibrator 302 may determine in the storage 310 the case profile corresponding to the case marker 130 detected in the video stream. As discussed elsewhere herein, the case profile of the protective cover device 100 may include one or more case attributes describing the protective cover device 100 (e.g., the width dimensions at various portions of the protective cover device 100, the distance between the bottom edge of the computing device 160 and the bottom edge of the protective cover device 100 when the computing device 160 is contained in the protective cover device 100, etc.).

In some embodiments, in addition to the case profile of the protective cover device 100, the calibrator 302 may also determine the stand profile of the stand 150. In some embodiments, if the stand marker 154 of the stand 150 is detected in the video stream, the calibrator 302 may determine in the storage 310 the stand profile of the stand 150 corresponding to the stand marker 154 detected in the video stream. Alternatively, the calibrator 302 may determine the device model of the computing device 160 that can be contained in the protective cover device 100. The calibrator 302 may then use the device model of the computing device 160 to determine the stand 150 on which the computing device 160 is placeable, and determine the stand profile of the stand 150 in the storage 310. In some embodiments, to determine the device model of the computing device 160, the calibrator 302 may analyze the case profile of the protective cover device 100, and determine the device model of the computing device 160 that can be contained in the protective cover device 100 based on the case profile of the protective cover device 100. Alternatively, the calibrator 302 may be implemented on the computing device 160 contained in the protective cover device 100. Therefore, the calibrator 302 may determine the device model of the computing device 160 to be the device model of the computing device 160 on which it is implemented.

In block 908, the calibrator 302 may determine the calibration profile based on the case profile of the protective cover device 100. The calibration profile may be determined based on the case profile of the protective cover device 100 and the stand profile of the stand 150. In some embodiments, the calibrator 302 may determine in the storage 310 the calibration profile associated with the case profile of the protective cover device 100 and the stand profile of the stand 150. The calibration profile may include calibration parameters for calibrating images captured by the camera 172 of the computing device 160 when the computing device 160 is installed in the protective cover device 100 and the protective cover device 100 containing the computing device 160 is situated on the stand 150. In some embodiments, the calibration profile may include the distance attribute indicating the distance between the camera 172 and the physical activity surface, the tilt attribute indicating the tilt angle of the camera 172 relative to the horizontal line, etc. Other calibration parameters are also possible and contemplated.

In some embodiments, instead of being associated with the case profile of the protective cover device 100 and the stand profile of the stand 150, the calibration profile may be associated with the camera position of the camera 172 of the computing device 160. Therefore, the calibrator 302 may determine the camera position of the camera 172 of the computing device 160 when the computing device 160 is covered in the protective cover device 100 and situated on the stand 150, and determine the calibration profile associated with this camera position in the storage 310. In some embodiments, to determine the camera position of camera 172 of the computing device 160, the calibrator 302 may determine the device model of the computing device 160 as discussed above, and determine the device attributes of the computing device 160 based on its device model. In some embodiments, if the computing device 160 is installed in the protective cover device 100, the calibrator 302 may also determine the case profile of the protective cover device 100 based on the case marker 130 of the protective cover device 100 as discussed above. The case profile may include the case attributes describing the protective cover device 100. In some embodiments, the calibrator 302 may also determine the stand profile of the stand 150 based on the stand marker 154 of the stand 150 and/or based on the device model of the computing device 160 being situated on stand 150 as discussed above. The stand profile of the stand 150 may include the stand attributes describing the stand 150.

In some embodiments, the calibrator 302 may determine the camera position of the camera 172 based on the device attributes of the computing device 160 (e.g., the distance between the camera 172 and the bottom edge of the computing device 160, etc.), the case attributes of the protective cover device 100 (e.g., the distance between the bottom edge of the computing device 160 and the bottom edge of the protective cover device 100 when the computing device 160 is covered in the protective cover device 100, etc.), and the stand attributes of the stand 150 (e.g., the distance the between the stand channel 156 of the stand 150 and the physical activity surface when the stand 150 is situated on the physical activity surface, etc.). For example, the calibrator 302 may determine the camera height of the camera 172 to be the sum of the distance between the camera 172 and the bottom edge of the computing device 160 (e.g., 23.5 cm), the distance between the bottom edge of the computing device 160 and the bottom edge of the protective cover device 100 if the computing device 160 is installed in the protective cover device 100 (e.g., 0.8 cm), and the distance the between the stand channel 156 of the stand 150 and the physical activity surface (e.g., 3.5 cm). The calibrator 302 may also determine the tilt angle of the camera 172 based on the height dimension of front portion and the height dimension of the back portion of the stand channel 156 of the stand 150. As discussed above, once the camera position of the camera 172 is determined, the calibrator 302 may determine the calibration profile associated with the camera position of the camera 172 in the storage 310.

In block 910, the calibrator 302 may process the video stream captured by the camera 172 using the calibration profile. In some embodiments, the calibrator 302 may apply the distance attribute, tilt attribute, and/or other calibration parameters in the calibration profile to process the images in the video stream and detect one or more tangible objects in the video stream. As discussed elsewhere herein, the activity applications 214 may then use the tangible objects detected in the video stream to perform their operations. Thus, based on the case marker 130 of the protective cover device 100 and/or the stand marker 154 of the stand 150 detected in the video stream, the calibrator 302 may determine the configuration in which the computing device 160 is set up and perform the image calibration on the video stream accordingly. The implementation of the case marker 130 and the stand marker 154 can eliminate the need for the user to input this data, thereby improving the user experience.

As depicted in FIGS. 1A and 5, the protective cover device 100 may include the ledge element 140 extending along one or more edges of the protective cover device 100. As depicted, the ledge element 140 may extend outward from the front surface of the protective cover device 100 to protect the display screen of the computing device 160. As an example, the computing device 160 covered in the protective cover device 100 may be dropped on a hard surface with the display screen 320 of the computing device 160 facing the hard surface (e.g., ground floor). Because the ledge element 140 raises above the front surface of the protective cover device 100, the ledge element 140 of the protective cover device 100 may be in contact with the hard surface instead of the display screen 320 of the computing device 160, thereby preventing the display screen 320 of the computing device 160 from being damaged. In some embodiments, the ledge element 140 may raise above the front surface of the protective cover device 100 by a height dimension that satisfies a height dimension threshold (e.g., more than 4 mm). In some embodiments, the ledge element 140 may include an impact absorbing material that can absorb a portion of an impact force applied to the protective cover device 100 containing the computing device 160, thereby effectively protecting the computing device 160 from damages. Non-limiting examples of the impact absorbing material include rubber, foam, viscoelastic polymer, etc. Other types of impact absorbing material are also possible and contemplated.

As discussed elsewhere herein, the stand 150 may include the stand channel 156 and the computing device 160 may be placeable in the stand channel 156 of the stand 150. When the computing device 160 is situated in the stand channel 156, at least a portion of the front surface, the back surface, and the bottom surface of the computing device 160 may respectively rest against the front surface, the back surface, and the bottom surface of the stand channel 156. In some embodiments, the computing device 160 may compatibly fit into the stand channel 156 of the stand 150. However, when the computing device 160 is contained in the protective cover device 100, the width dimension of the protective cover device 100 containing the computing device 160 may be larger than the width dimension of the computing device 160. The ledge element 140 extending outward from the front surface of the protective cover device 100 may further increase the width dimension of the protective cover device 100 at the ledge element 140. Therefore, the protective cover device 100 containing the computing device 160 may not fit into the stand channel 156 of the stand 150 because of the larger dimensions of the protective cover device 100.

In some embodiments, the protective cover device 100 may be adapted so that the protective cover device 100 containing the computing device 160 may be placeable in the stand channel 156 of the stand 150 regardless of its increased width dimension as compared to the computing device 160. As depicted in FIG. 1A, the protective cover device 100 may include an exterior portion 110 extending along one or more edges of the protective cover device 100. As an example, the exterior portion 110 may be an area on the front surface of the protective cover device 100 that extends along the edges of the protective cover device 100 and has the height dimension of 2 cm from the corresponding edge of the protective cover device 100. In some embodiments, the width dimension of the protective cover device 100 at the exterior portion 110 may be compatible with the width dimension of the stand channel 156 of the stand 150. For example, the width dimension of the protective cover device 100 may be decreased at the exterior portion 110 to be substantially equal to or less than the width dimension of the stand channel 156. In some embodiments, the width difference between the width dimension of the protective cover device 100 at the exterior portion 110 and the width dimension of the stand channel 156 may satisfy a width difference threshold (e.g., less than 1.5 mm). In some implementations, the width dimensions of the protective cover device 100 at the exterior portion 110 may be substantially similar to the width dimensions of the computing device 160. As a result, the exterior portion 110 of the protective cover device 100 can be accommodated in the stand channel 156, and thus the stand channel 156 of the stand 150 may receive the protective cover device 100 containing the computing device 160 at the exterior portion 110 of the protective cover device 100.

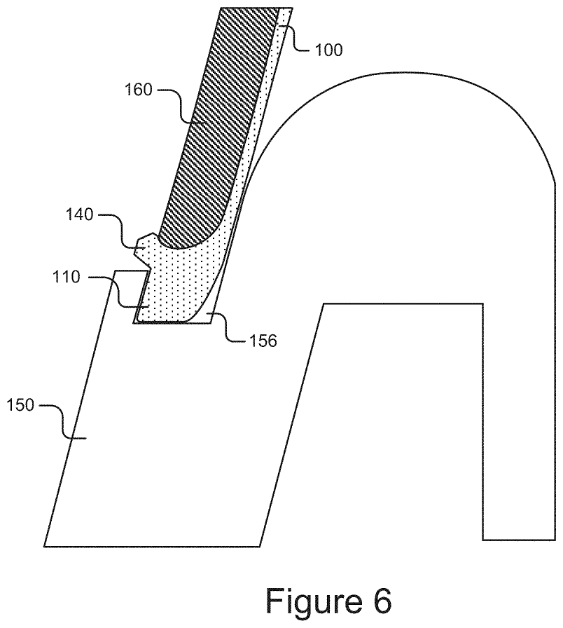

FIG. 6 illustrates a cross-sectional view of the protective cover device 100 containing the computing device 160 and situated in the stand channel 156 of the stand 150. As depicted, the protective cover device 100 may include the exterior portion 110 located between the ledge element 140 and the corresponding edge of the protective cover device 100 along which the ledge element 140 may extend. As discussed above, the width dimension of the protective cover device 100 at the exterior portion 110 may be compatible with the width dimension of the stand channel 156 of the stand 150. Therefore, the protective cover device 100 containing the computing device 160 may fit into the stand channel 156 at the exterior portion 110 while its remaining portions may not because of their increased width dimensions.

As depicted in FIG. 6, the height dimension of the exterior portion 110 may also be compatible with the depth dimension of the stand channel 156 of the stand 150. The depth dimension of the stand channel 156 may be the distance between the top surface of the front portion of the stand channel 156 and the bottom surface of the stand channel 156 against which the edge of the protective cover device 100 may rest. In some embodiments, the height dimension of the exterior portion 110 may be substantially equal to or higher than the depth dimension of the stand channel 156. As the exterior portion 110 may be located between the ledge element 140 and the corresponding edge of the protective cover device 100, this height dimension of the exterior portion 110 may enable the exterior portion 110 to fit into the stand channel 156 with the ledge element 140 located above the stand channel 156 and not interfering with the front portion of the stand channel 156 as depicted in FIG. 6. Therefore, the protective cover device 100 containing the computing device 160 may be received in the stand channel 156 of the stand 150 despite the ledge element 140 outwardly protruding from the front surface of the protective cover device 100.

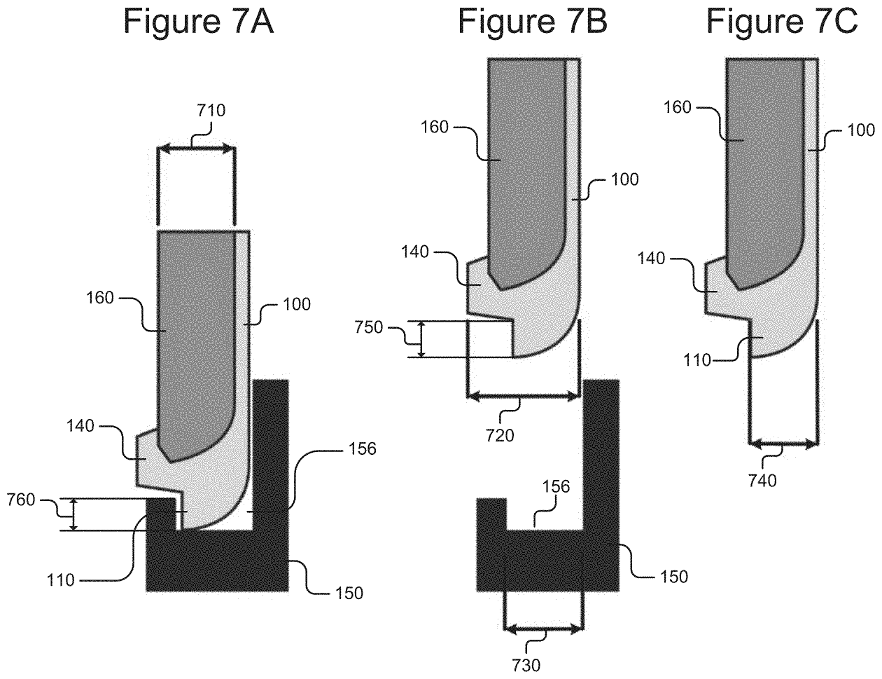

FIGS. 7A-7C illustrate cross-sectional views of the protective cover device 100 containing the computing device 160 relative to the stand channel 156 of the stand 150. As depicted in FIGS. 7A and 7B, the computing device 160 installed in the protective cover device 100 may have the width dimension 710, and the stand channel 156 of the stand 150 may have the width dimension 730. As discussed above, the width dimension 710 of the computing device 160 may be substantially equal to the width dimension 730 of the stand channel 156, and thus the computing device 160 may be compatibly placed in the stand channel 156 of the stand 150.

As depicted in FIG. 7B, the protective cover device 100 may have the width dimension 720 at the ledge element 140. The width dimension 720 of the protective cover device 100 at the ledge element 140 may be higher than the width dimension 710 of the computing device 160 due to the thickness of the protective cover device 100 that covers the computing device 160 and the outward protrusion of the ledge element 140 from the front surface of the protective cover device 100. Therefore, the width dimension 720 of the protective cover device 100 at the ledge element 140 may be larger than the width dimension 730 of the stand channel 156, and thus the protective cover device 100 containing the computing device 160 may not fit into the stand channel 156 of the stand 150 at this portion.

As depicted in FIGS. 7A and 7C, the protective cover device 100 may include the exterior portion 110 located between the ledge element 140 and the corresponding edge of the protective cover device 100. The width dimension 740 of the protective cover device 100 at the exterior portion 110 may be substantially equal to the width dimension 710 of the computing device 160, and thus also substantially equal to the width dimension 730 of the stand channel 156. Therefore, the protective cover device 100 containing the computing device 160 may be placed on the stand 150 as depicted in FIG. 7A with the exterior portion 110 of the protective cover device 100 being compatibly received in the stand channel 156 of the stand 150. As depicted, the height dimension 750 of the exterior portion 110 may be larger than the depth dimension 760 of the stand channel 156. Thus, as the bottom edge of the protective cover device 100 rests against the bottom surface of the stand channel 156, the ledge element 140 of the protective cover device 100 may be located above the front portion of the stand channel 156 without interfering with this front portion as depicted in FIG. 7A. Due to the exterior portion 110 of the protective cover device 100, the protective cover device 100 containing the computing device 160 can be situated on the stand 150 that is designed to compatibly fit the computing device 160. Thus, the user may use the stand 150 to position the computing device 160 covered in the protective cover device 100. As a result, the risk of the computing device 160 being damaged can be lowered without incurring additional device cost.

FIG. 8 illustrates the protective cover device 100 containing the computing device 160 and situated on the stand 150 in the horizontal position. In some embodiments, to place the protective cover device 100 containing the computing device 160 on the stand 150 in different positions, the protective cover device 100 may include multiple exterior portions 110 extending along multiple edges of the protective cover device 100. For each exterior portion 110, the width dimension of the protective cover device 100 the at the exterior portion 110 may be compatible with the width dimension of the stand channel 156 of the stand 150, and the height dimension of the exterior portion 110 may be compatible with the depth dimension of the stand channel 156 of the stand 150 as discussed above. Therefore, the exterior portions 110 along different edges of the protective cover device 100 may fit into the stand channel 156 of the stand 150, and thus different edges of the protective cover device 100 may be received in the stand channel 156 of the stand 150 at the corresponding exterior portion 110. As a result, the user may place the protective cover device 100 containing the computing device 160 on the stand 150 with different edges of the protective cover device 100 resting in the stand channel 156 of the stand 150, thereby situating the computing device 160 covered in the protective cover device 100 in different positions.

It should be understood that the above-described example activities are provided by way of illustration and not limitation and that numerous additional use cases are contemplated and encompassed by the present disclosure. In the above description, for purposes of explanation, numerous specific details are set forth in order to provide a thorough understanding of the present disclosure. However, it should be understood that the technology described herein may be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of a hardware implementation, a software implementation, or implementations containing both hardware and software elements. For instance, the technology may be implemented in software, which includes but is not limited to firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi™) transceivers, Ethernet adapters, and modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats.

Furthermore, the modules, routines, features, attributes, methodologies and other aspects of the disclosure can be implemented as software, hardware, firmware, or any combination of the foregoing. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment. Accordingly, the disclosure is intended to be illustrative, but not limiting, of the scope of the subject matter set forth in the following claims.

What is claimed is:

1. A protective cover device comprising:
a top surface;
a back surface connected to the top surface, the top surface and the back surface extending around one or more device surfaces of a computing device; and
an adapter window including a portion of the top surface and a portion of the back surface, the adapter window being movable relative to the protective cover device to expose a device edge of the computing device to receive a camera adapter.

2. The protective cover device of claim 1, wherein:
the device edge of the computing device is exposed when the adapter window is at an open position; and
the camera adapter is compatibly placeable on an exposed portion of the device edge of the computing device.

3. The protective cover device of claim 1, wherein:
the adapter window is connected to a surface of the protective cover device at a connecting element, the adapter window being rotatable around the connecting element relative to the surface of the protective cover device to an open position; and
the surface of the protective cover device is the top surface or the back surface of the protective cover device.

4. The protective cover device of claim 3, wherein:
the adapter window is rotatable around the connecting element by a rotation angle satisfying a rotation angle threshold.

5. The protective cover device of claim 3, wherein:
the adapter window rests against the surface of the protective cover device when the adapter window is at the open position.

6. The protective cover device of claim 5, wherein:
the surface of the protective cover device includes a first area adapted to receive the adapter window when the adapter window is at the open position; and
the adapter window is detachably coupleable to the first area.

7. The protective cover device of claim 6, wherein:
the first area is an indent portion compatible with the adapter window on the surface of the protective cover device, the adapter window being flush with the surface of the protective cover device when the adapter window is in the first area.

8. The protective cover device of claim 1, wherein:
the adapter window rests against the camera adapter that is situated on the device edge of the computing device when the adapter window is at an open position.

9. The protective cover device of claim 1, further comprising:
a case marker indicating that the computing device is installed in the protective cover device.

10. The protective cover device of claim 9, wherein:
the case marker is positioned at a bottom area on a front surface of the protective cover device and located within a field of view of a camera of the computing device.

11. The protective cover device of claim 9, wherein:
the protective cover device containing the computing device is placeable on a stand, the stand including a stand marker positioned on a front portion of the stand; and
the case marker of the protective cover device blocks the stand marker of the stand from being visually detectable to a camera of the computing device when the protective cover device containing the computing device is situated on the stand.

12. The protective cover device of claim 11, wherein:
the stand marker is positioned on an indent area of the front portion of the stand; and
the case marker includes a protrusion extending outward from a front surface of the protective cover device, the protrusion of the case marker occupying a space above the indent area of the stand and blocking the stand marker on the indent area of the stand from the camera of the computing device.

13. The protective cover device of claim 1, wherein:
the protective cover device containing the computing device is placeable in a stand channel of a stand; and
the protective cover device includes an exterior portion along an edge of the protective cover device, a width dimension of the protective cover device at the exterior portion being compatible with a width dimension of the stand channel of the stand.

14. The protective cover device of claim 1, further comprising:
a ledge element extending outward from a front surface of the protective cover device and along an edge of the protective cover device.

15. The protective cover device of claim 14, wherein:
the protective cover device containing the computing device is placeable in a stand channel of a stand; and
the protective cover device includes an exterior portion located between the ledge element and the edge of the protective cover device, a width dimension of the protective cover device at the exterior portion being compatible with a width dimension of the stand channel of the stand.

16. The protective cover device of claim 15, wherein:
a height dimension of the exterior portion of the protective cover device is compatible with a depth dimension of the stand channel of the stand.

17. A protective cover device comprising:
a top surface;
a back surface connected to the top surface, the top surface and the back surface extending around one or more device surfaces of a computing device; and
an adapter window including a portion of the top surface and a portion of the back surface, the adapter window being movable relative to the protective cover device to expose a device edge of the computing device to receive a camera adapter, the camera adapter being placeable on an exposed portion of the device edge and over a camera of the computing device to direct a field of view of the camera of the computing device.

18. The protective cover device of claim 17, further comprising:
a case marker indicating that the computing device is installed in the protective cover device.

19. The protective cover device of claim 18, wherein:
the case marker is positioned at a bottom area on a front surface of the protective cover device and located within the field of view of the camera of the computing device; and
the computing device is adapted to:
capture, using the camera of the computing device, a video stream;
detect in the video stream, using a detector executable on the computing device, the case marker positioned on the protective cover device; and
determine that the computing device is installed in the protective cover device.

20. A protective cover device comprising:
a top surface;
a back surface connected to the top surface, the top surface and the back surface extending around one or more device surfaces of a computing device;
an adapter window including a portion of the top surface and a portion of the back surface, the adapter window being movable relative to the protective cover device to expose a device edge of the computing device to receive a camera adapter, the camera adapter being placeable on an exposed portion of the device edge and over a camera of the computing device;
a case marker positioned at a bottom area on a front surface of the protective cover device and located within a field of view of the camera of the computing device, the case marker indicating that the computing device is installed in the protective cover device;
a ledge element extending outward from the front surface of the protective cover device and along an edge of the protective cover device; and
an exterior portion located between the ledge element and the edge of the protective cover device, wherein
a width dimension of the protective cover device at the exterior portion is compatible with a width dimension of a stand channel of a stand in which the protective cover device containing the computing device is placeable; and
a height dimension of the exterior portion of the protective cover device is compatible with a depth dimension of the stand channel of the stand.
